(19) United States
(12) Patent Application Publication
(10) Pub. No.: US 2008/0121108 A1
(43) Pub. Date: May 29, 2008

(54) Method and System for Rapid Automated Extraction and Other Processes Using Controllable Temperature and Pressure

(76) Inventor: Wayne Albert Vicker, Palo Alto, CA (US)

Correspondence Address: Wayne Vicker, 1444 Hamilton Avenue, Palo Alto, CA, 94301, US

(21) Appl. No.: 11/666,559

(22) PCT Filed: Nov. 9, 2005
(86) PCT No.: PCT/US05/40536

§ 371 Date: Sep. 25, 2007

Related U.S. Application Data
(60) Provisional application No. 60/626,805, filed on Nov. 10, 2004.
(60) Provisional application No. 60/639,680, filed on Dec. 28, 2004.

(51) Int. Cl. A47J 31/00

(52) U.S. Cl. 99/279

(57) ABSTRACT

A high through-put high efficiency system for extracting, extruding, purifying, mixing, or otherwise preparing known, new, useful or potable elements from substances where such system employs controllable pressure and temperature. The invention further provides an apparatus (30) for producing aerated consumable fluid at a selectable temperature. The invention employs a porous filter (44) of pre-selected porosity to foam hot or cold fluid commingled with a pressurized gas.

### RELATED APPLICATIONS

This application claims priority from US provisional application, 60/626,805 filed Nov. 10, 2004, of the same title and inventor, the entirety of which is incorporated herein. This application is also related to U.S. provisional No. 60/639,680, by the same inventor, filed Dec. 28, 2004, and incorporated herein in its entirety.

### GOVERNMENT FUNDING

Not Applicable.

### BACKGROUND

Extraction by means of a fluid is routinely used in many industrial and consumer applications. Often, the quality of the extraction is a function of operator training and skill. In many large scale or high through put systems, the need exists for automation of the extraction process, and quality control independent of operator skill.

Consumer oriented extraction systems include those designed for beverage preparation. Specifically, hot and cold beverages of bean, leaf or other plant or animal products derivatives such as coffee, tea, soy, milk or cocoa are prepared daily around the world. The current retail equipment by and large requires operator training. Moreover, the commercially available large through-put systems waste a high percentage (around two thirds) of the beverage or consumable extractant material. The extractant is not efficiently or effectively exposed to the extracting fluid. Further, quality of output is variable and the system failure rate approaches 20% in retail establishments; inconsistent beverage quality and variable delays in product delivery are sources of customer dissatisfaction. Effluent quality varies owing to inaccurate or inexpert monitoring of temperature and other preparation conditions of the extraction.

Further, the ability to retrofit in place beverage delivery systems is lacking. The need to provide effective retrofit modules to commercial consumer oriented extraction delivery systems exists.

The ability to standardize extraction material input portions without requiring specialized or proprietary input receptacles, or portions packaged in metal or other non-renewable material is needed.

The need exists for uniform, controllable pressure and a wide range of controllable temperatures experienced by the material under extraction. This is especially true if a single device is desired to produce, for example both hot and cold drinks or consumables.

A need for a fully automated vending type beverage delivery system for freshly made consumables, and, most particularly a system capable of producing both hot and cold consumables, including, particularly, the ability to produce cold frothy milk without altering the milk concentration, exists. Currently, hot milk froth is added to cold coffee or similar beverages thereby raising the temperature of the cold drink. Moreover, the delivery of consumable products with a minimization of non-renewable resources used in both the consumable creation and the consumable delivery is desired.

In many contemporary beverages or food preparation processes, it is desirable to produce a froth or foam from a liquid. For example, it is ubiquitous amongst coffee purveyors to offer beverages such as “cappuccino” or “latte” which ordinarily require the addition of foamed or steamed milk or milk equivalent (e.g. non-dairy liquid such as soy or other liquid additives). For simplicity, the use of the term “milk” herein shall mean any fluid from which a froth or foam is desired. In addition to the commercial beverage purveyors, many devices intended for home or non-commercial use provide a means for producing steamed milk or froth. In whatever venue, the quality of the output is a function of operator experience, and requires the operator know the “sound” associated with the foaming process, as well as a number of preparation factors (timing, volume, beverage characteristics such as fat content or sediment density, to name a few).

Rapid customer service is impeded as the frothing requires significantly more than the time required to brew the coffee of other beverage. And operator failure in frothing technique results in customer insistence the beverage be re-made or the decision not to patronize the establishment. The implications of slow and or inferior beverage production may harm franchises as well as independent operators. Increased operator training can only address half the problem, as current devices cannot froth faster than the coffee is brewed. What is needed is an operator error proof, faster frothing device.

The current devices for so frothing milk rely on heat and produce a hot milk product. The process of adding hot milk to a drink intended to be consumed in a chilled state produces a rise in the consumption temperature or a dilution of the drink concentration by the addition of ice. What is needed is a means to produce a cold froth without dilution of the resulting beverage. Further, the ability to produce both cold or hot milky foam quickly and in a high volume through put suitable for retail beverage purveyors is highly desirable. Moreover, a portable product suitable for light and economical home use is desired.

And further, hot or cold milk by itself or in combination with other potables (coffee, hot chocolate, tea and the like) obtained form a vending apparatus is desired. Further needed is a conversion means for current beverage producing apparatus operable to enable the converted apparatus to produce a variety of foamy consumables from an automatic or semi automatic system. Such system may feature selectable temperature, pressure and effluent conditions that are predetermined, thereby simplifying operation of device, eliminating the skill disparities among operators, and enabling a wide consumable selection choice without necessitating dedicated machines occupying valuable counter space.

Further needed is a means to convert current beverage machines to high through-put devices, and to efficiently use beverage or consumable materials currently unexposed to the extracting or carrier fluid in current machines. For example, the typical food industry coffee maker uses only the top one third of the coffee to extract flavor, and the remaining two thirds of the coffee material is wasted i.e. does not contribute significantly to the beverage potency.

Further needed is a conversion means for devices to produce a variety of consumables from an automatic or semi automatic system, where such system should feature selectable temperature, pressure and effluent conditions that are predetermined, thereby simplifying operation of device while enabling a wide consumable selection choice.

Further needed is a means of applying automated high through-put extraction or other processing system to the discovery of and research related to biological, chemical or biochemical substances, whether or not consumable, where the processing system operator need not be highly trained. Automatic or semi-automatic high through-put devices easily adaptable to extraction or purification or other target material manipulation, using a variety of fluids and at temperatures ranging between sub zero and boiling points of the fluid or fluids in use are needed.

Further needed is a automated or semi automated high through-put fluid aided extrusion device, operable so that predetermined amounts of extrudant are output under controllable temperature and pressure. In some cases, the need is to facilitate the commingling of target materials to produce a combination or some physical or chemical nature as part of the automated or semi-automated process. Conversely, the exposure of target materials to pre-selected temperature and pressure, whether or not in the presence of fluid, may operate to remove or separate elements physically or chemically from the target material as part of the automated or semi automated process. What is also needed is the capability of combining the governable temperature and pressure environment experienced by the target material with other techniques, including, but limited to IR and ultrasound.

### BRIEF DESCRIPTION OF THE INVENTION

The invention taught herein provides satisfaction of each of the articulated and unmet needs set forth hereinabove. The invention provides a fully or semi-automatic controllable temperature and pressure system that requires little or no operator skill. Hereafter, we often refer to extraction as the process taking place in the controllable system. However, it should be understood that any process or part of a process amenable to a controllable temperature and pressure environment for target substances may employ the invention taught herein. Further, while ingestible output, whether by humans, animals or otherwise, is often referenced (i.e. by the term “beverage”, “consumable”, or the like) the inventive process may be applied to target materials where the use for the output is not for consumption, or may be of entirely unknown application, such as exotic plant, animal or fungus extractions, or materials as novel as insect parts, minerals, or inorganic matter.

The invention further provides a high through-put system for processes that are amenable to producing consumer beverages. The term beverage includes but is not limited to ingestible material for either human or animal life forms, and may include gels, mousse, foams, slurries or any other texture or combination of textures. In a preferred embodiment, the invention provides a means for economically using the material under extraction and minimizing or eliminating waste. The invention provides a means to convert commercial beverage making devices currently in use to efficient, automated or semi-automated high through-put devices.

The inventive system builds on the inventor's prior issued patent, U.S. Pat. No. 5,134,924 for an automated coffee or beverage making device, which is incorporated by reference as if fully set forth herein. The improved inventive system provides for the application of controllable temperature and pressure to effect the desired extraction or other process, whether such processes require hot or cold temperatures. In the case of water based extraction of ground coffee bean material for the purpose of a potable fluid (i.e. a beverage commonly denominated as “coffee”) the temperature range of the water in contact with the extractant material is optimally between 201 and 206 degrees Fahrenheit.

The pressure experienced by the extractant material varies controllably relative to the material. For a coffee bean grind optimal for a so-called espresso coffee beverage, the fluid introduction pressure is in the range of 130-150 pounds per square inch. The invention provides a configuration that creates back pressure which ensures uniform distribution of pressure throughout the extractant material. The invention also provides that substantially all of extractant material come into contact with the extracting fluid at the appropriate temperature and pressure so as to derive the benefit of the material in the palliative or potency characteristics of the output material.

In the case of the inventive high through-put system, the back pressure created is not solely a function of the extractant material fill configuration. Nor does back pressure depend exclusively on the pressurized introduction of the pre-selected fluid. Rather, the receptacle (receiving pocket) for the extractant material itself features a predetermined geometry such that a back pressure is exerted on the extracting fluid uniformly throughout the extractant material.

In a preferred embodiment wherein the extractant is about 14 grams of espresso type dry coffee, and the fluid is water at 203 to 206 degrees Fahrenheit, the invention provides a potable effluent discharge in 8 seconds or less. The preferred embodiment uses water introduced into the receiving pocket from a plurality of individual channels at a pressure of 130-160 psi. The geometry of the receiving pocket, including the diameter of the outlet aperture (open end) and the fit of the bottom screen in the receiving pocket contributes to a “back pressure” on the extractant material, providing both exceptional quality, efficient extraction of substantially all the extractant material.

The geometry includes an outlet aperture with a diameter in the range of 35/1000 ths to 150/1000 ths of an inch when the screen thickness in the bottom of the pocket is between 0.010 and 0.020 thick. The screen is composed of stainless steel or any material that can perform under operational conditions as well as flex similarly under operating conditions to approach communication with the top of the outlet aperture yet retain enough airspace to enable the easy exit of effluent through the open end.

In any of the embodiments discussed herein, extractant material may be loose or in a preformed packet (e.g. a packet as described in U.S. Pat. No. 5,134,924). Alternatively, a packet can be designed with a built in screen element, achieving the requisite close communication with the floor of the receiving pocket and associated effluent outlet means.

In some processes, the desired material may also be that remaining in the packet or receiving pocket itself. It may be desirable to dynamically alter the open end diameter either during a process or rapidly between successive operations. Such dynamic aperture control can be accomplished in a number of ways, as can the governing of the temperature and pressure as well as screen means characteristics associated with the inventive process. Simply put, either selectable settings may be chosen by the operator, including aperture diameter, or the aperture may be manually governed during system operation. The benefits of dynamically controllable elements are easily understood. The automation of such elements to accommodate either a consumer or an unskilled operator can be accomplished using either stock materials or customization is always possible

Other embodiments include large volume brewing of non-espresso coffee. This embodiment employs a large receiving pocket and a different thickness screen and selected diameter of the open end to govern the quality of the beverage yet produce high effluent production rate compared with food and restaurant industry standards.

In another embodiment, the receiving pocket is a “retrofit” insert into standard drip or brew type coffee maker. The retrofit receiving pocket may be inserted into a commercial grade coffee maker, and a retrofit head adapted to introduce water of pre-selected temperature into a modified receiving chamber, increasing the brewing temperature and pressure, and accelerating the production of coffee, whether in large or small amounts, and ensuring the contribution of substantially all the coffee material to the resulting consumable.

In another embodiment, the retrofit receiving pocket is specifically designed for a commercial espresso type coffee maker. The retrofit receiving pocket provides the optimal geometry for a faster effluent, with full extraction of the material under extraction. Using the principles of the invention taught herein, it is possible to further retrofit the receiving pocket with a pre-selected geometry specifically adapted to the introduction of milk, subjectable to a frothing element (typically air, although other agents may be used) or any substance from which a cold or hot froth is desired, and to produce a frothy variant at the desired temperature.

The term beverage includes but is not limited to ingestible material for either human or animal life forms, and may include gels, mousse, foams, slurries or any other texture or combination of textures or temperatures. The invention provides a means to add functionality to commercial beverage making devices (e.g. espresso machines) currently in use to a machine so as to render such machines capable of producing additive froth or foam of varying temperatures and from a variety of potable liquids.

The inventive device includes a governable means for fluid conveyance, a governable means for pressurized gas (air or other gaseous source), a chamber where the fluid and the pressurized gas commingle, and an output path from the chamber characterized by a filter element of pre-selected porosity operable to foam or froth the fluid-gas combination.

In one embodiment, the filter element is selectable, thereby accommodating fluids of varying sediment or fat content, or other factors that impact obtaining the desired consistency of output.

The source liquid may be chilled in a source reservoir and the resulting output at or near the source temperature. In another embodiment, a governable heater element is included in the fluid flow means, enabling control of the temperature of the fluid. Typically, the fluid for commercial beverages may be desired at sub-boiling temperatures. The temperature may be regulated to accommodate the desired output in consideration of the fluid and the temperature of the source fluid. A heat source of microwave or ultrasound, or both, or any equivalent may be used.

In another embodiment, the invention is a “retro-fit” module capable of coupling with standard espresso type commercial or domestic coffee makers. The gas source may be a connection to a large volume source (tank), or a canister that can be periodically replaced. The gas may be air, NO₂ or any other gas suitable for a consumable.

In another embodiment, the invention is further adapted for a consumer vending type device, selectable for various beverages and combinations of consumables, including beverages and additives (milk, sugar, foamed milk, cocoa, adjuvants, etc). In addition to the modification necessary for integrating the invention into such a commercial apparatus, the filter feature is controllable and automatically adjustable to correspond to the proper porosity for the selected beverage. This may be accomplished by a removable filter element for non-automatic embodiments. Alternatively, to accommodate automation, a variety of chamber outlets with porous filter elements may be provided, for example in a rotate-able wheel or similar configuration and the chamber output variably rotated so as to align with the porosity filter element predetermined as optimal for the selected beverage or beverage elements.

In another embodiment, the automated device of U.S. Pat. No. 5,134,924 is further adapted for a consumer vending type device, selectable for various beverages and combinations of consumables, including beverages and additives (milk, sugar, foamed milk, cocoa, adjuvants, etc). Modifications include a variety of receiving pockets that rotate into operable position according to the beverage selection. Receiving pockets are adapted as to outlet aperture and screen thickness that correspond to the optimal conditions for the selected consumable and the concomitant extractant material form (raw, roasted, ground or freeze dried cocoa beans, ground soy bean, coffee beans, tea leaves, other bean, leaf, herb, raw, dried or fermented legume, grain, vegetable, fruit, nut or any other extractant material). This is further adaptable to milk-based beverages or beverage additions. It is further adaptable to preservation, inclusion, or introduction of substances (either naturally or synthetically sourced) of nutritional, pharmaceutical, or otherwise beneficial qualities for humans or animals, including but not limited to polyphenols, procyanids, nattokinase.

In another embodiment of the invention, the extractant may be potable, medicinal, or not intended for consumption. The inventive device can be applied to vegetative substances (bark, root, leaves, twigs, berries) or any variety of matter (insect parts, fungus, etc) for which the use or uses may be unknown or insufficiently characterized. The extraction can be applied in purification processes preliminary to other investigative chemical, biochemical or biological procedures. The device may also be applied to the extrusion of liquid, semi liquid, or gel phase materials in manufacturing processes where a controlled extrusion is desired.

In another embodiment of the invention, a retrofit module for the device of U.S. Pat. No. 5,134,924 consisting of a series of receiving pockets with variable outlet apertures and screen thicknesses and compositions. An alternate/improved cam drive useful in the device taught in U.S. Pat. No. 5,134,924 is also taught herein.

### BRIEF DESCRIPTION OF THE DRAWINGS

FIG. 1 is a cross section of a receiving pocket according to the present invention.

FIG. 2 is an expanded cross section of a receiving pocket according to the present invention.

FIG. 3 is a schematic representation of a frothing apparatus according to the invention.

### DETAILED DESCRIPTION OF THE PREFERRED EMBODIMENT

The overall mechanical system for automated through-put is as described in U.S. Pat. No. 5,134,924 which is incorporated by reference as if fully set forth herein. Many features do not need to be depicted to be understood; moreover, the figures herein are not to scale.

Many of the applications described in the summary will be understood to anyone equipped with an understanding of the invention as taught in U.S. Pat. No. 5,134,924 and an average skill in the relevant arts. Thus the brevity of the description in no way compromises the scope of applications to which the invention taught may be employed.

The automatic features of the invention in any process requiring controlled temperature and pressure during processes including but not limited to extraction, extrusion, purification, separation, mixing (e.g. emulsion, suspension, gel, colloidal) are understandable from the principles set forth herein, and the exemplar preferred embodiment, without undue experimentation. Pertinent details concerning controllable temperature and pressure, the fluid introduction, and the conditions under which the extractant or other source material yields an effluent or other desired output are set forth herein as respects a preferred embodiment.

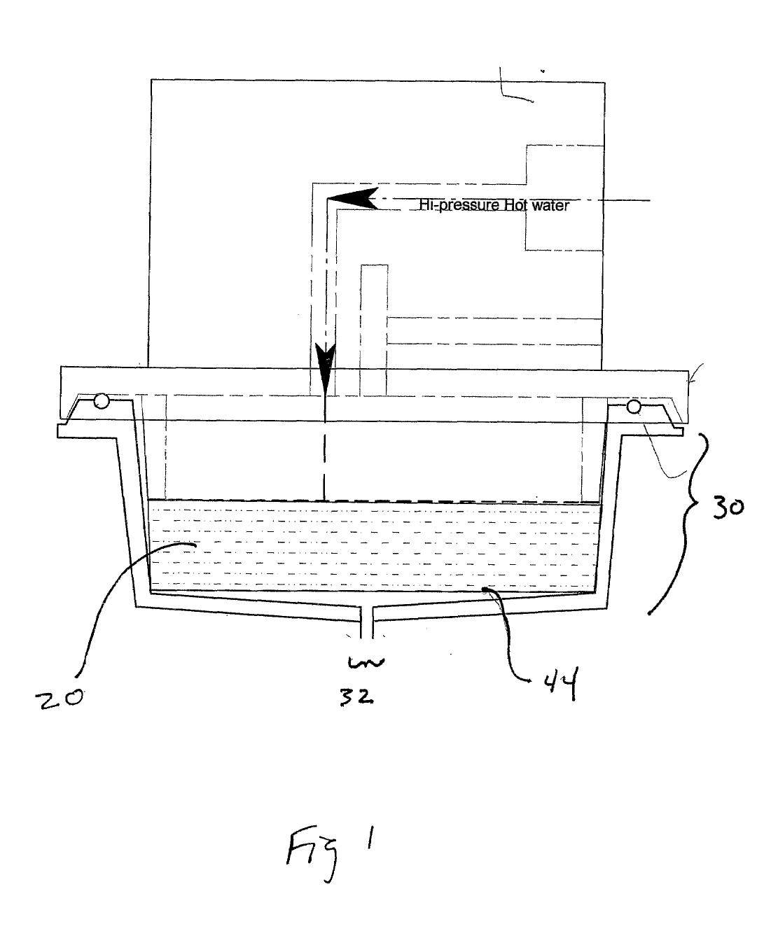

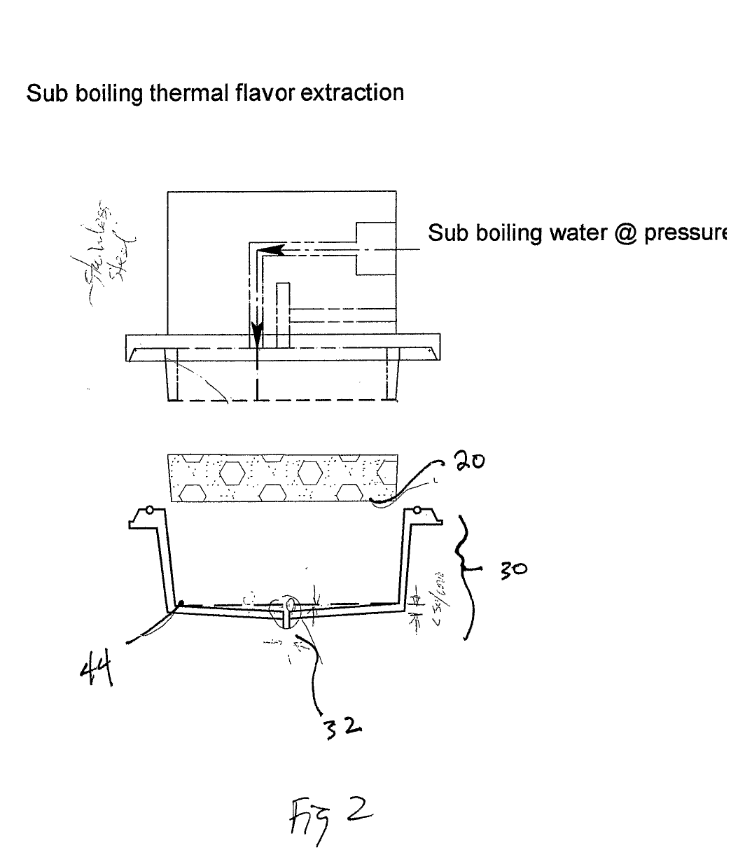

A preferred embodiment of the invention is a system for extracting a potable coffee beverage. More specifically, an automatic or semi automatic high through-put system for extracting an espresso coffee beverage in about 8 seconds or less is described. The invention provides a means for controllable temperature and pressure for use in systems such as that taught in U.S. Pat. No. 5,134,924, and like extraction systems. FIGS. 1 and 2 depict elements that numerically correspond to elements in the figures accompanying U.S. Pat. No. 5,134,924.

In the preferred embodiment, the invention provides a receiving pocket (30 in FIG. 1) geometrically shaped to minimize the distance between the extractant packet 20 and the open end 32 of the receiving pocket 30 and where the open end 32 is an aperture of pre-selected diameter above which is a screen 44 of predetermined thickness wherein the open-end aperture and the screen 44 characteristics cooperate so as to produce controllable back pressure during the introduction of fluid into the receiving pocket.

According to the preferred embodiment, a predetermined portion of espresso grind coffee is introduced into the receiving pocket. The coffee may be in a contained portion similar to that described in U.S. Pat. No. 5,134,924, or in some other packet, or in loose form. Roughly 14 grams of coffee produces a single serving. Introduction of the water through a delivery head [item 34 in FIG. 8 of U.S. Pat. No. 5,134,924] at a temperature of 201-206 degrees Fahrenheit, and at a pump pressure of 130-150 pounds per square inch.

A cup or other collection means captures the effluent flowing from the open end 32 of the receiving pocket 30. The geometry includes an open end 34 aperture in the range of 35/1000ths to 150/1000ths of an inch when the screen 44 thickness in the bottom of the receiving pocket 30 is between 0.010 and 0.020 inches thick. The angle of the receiving pocket floor is slight, being the smallest angle enabling direction of the effluent through the open end 32 aperture.

In the case of cold milk based output (typically foam or froth when associated with retail coffee) the device is adaptable to deliver cold froth based on the same principles of controlled temperature and pressure, and predetermined geometry of the outlet aperture. Porcelain screen element (rather than stainless steel) is preferred for delivery of frothy cold or hot milk and the introduction of air rather than water, where the milk source is in a fluid form. The pocket in which the air and milk interface is subject to various configurations according to the principles set forth herein.

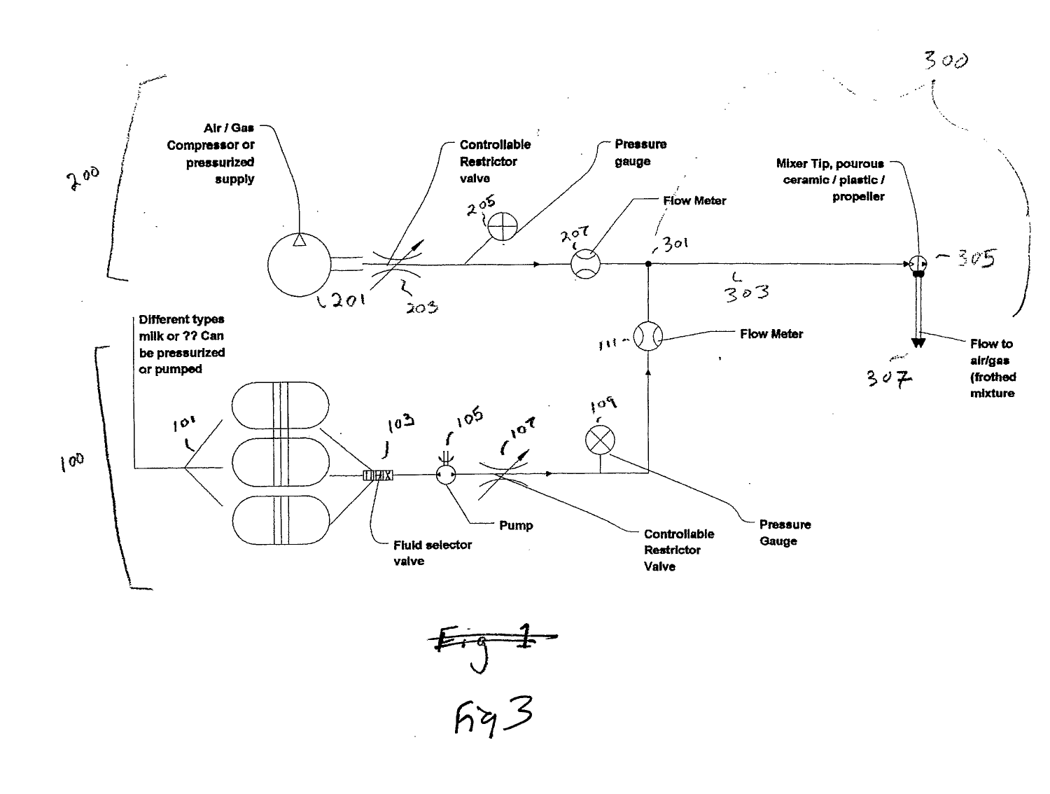

Referring to FIG. 3, an apparatus according to the present invention provides a fluid line, 100, comprising a beverage source 101, a fluid selection valve 103, a pump 105, a first controllable restrictor valve 107, a first pressure gauge 109, and a first flow meter 111, and a gas line 200 comprising a pressurized gas source 201, a second controllable restrictor valve 203, a second pressure gauge 205, a second flow meter 207, and a common line 300, where the fluid line and the gas line intersect 301 and the fluid and gas line contents proceed in a common line 303 pass through a porous feature 305 and exit though an output aperture 307.

The lines are typically of NSF stainless steel or NSF plastic tubing with an inner diameter of ¼ inch. The length is governed by the geometry of the appliance and the intended use (domestic, commercial, etc.)

The fluid is, in the preferred embodiment, a chilled beverage, and the gas under pressure between twenty and eighty pounds per square inch, with average operation in the mid pressure ranges. In an alternate embodiment, a heater element (not shown) is added in the fluid line operable, though microwave, ultrasound or other known operations, heat the fluid to a governable temperature.

For immediately consumable beverage preparation, the upper limit of desired heating is sub-boiling. The gas source may be pressurized by a number of means, including but not limited to a compressor or any variety of so called “canned pressure”.

The porous feature 305 in the preferred embodiment is a screw on housing of ½ inch diameter containing a porous disc (not shown) of 3/16 inch thickness. The porous disc may be of ceramic or suitable plastic or similar material, provided the porosity is determinable and the material meets the applicable safety requirements.

The porous feature 305 as a whole or the porous disc alone may be discardable after its useful life is expired, such life being determined by degradation in performance owing to change in desired porosity.

Moreover, a fan type bladed propeller, paddle or other suitable wiper element may be coupled to the porous element, or substitute for the porous element, to assist in the flow of higher density liquids (e.g. whole milk, chocolate milk). Such a fan or wiper may be of a propeller or paddle design operable to rotate simply by virtue of flow in the tubing.

The commercial and domestic designs do not require further elaboration to understand, as the manner of arranging the geometry of the components is determined by the device being fitted with the inventive apparatus. All fittings, couplings, removable replaceable or selectable parts are non-custom and choice of and combination of parts governed by the particularities of the system under fit.

As regards the consumer vending apparatus, all the requisite elements, (rotary selection wheel, solenoids, control circuitry, etc) are well known already in the beverage vending arena. This is true for both hot and cold beverage vending. Reference is made to U.S. Pat. No. 5,134,924 as an example.

Pertinent details concerning controllable temperature and pressure, the fluid introduction, and the conditions under which the extractant or other source material yields an effluent or other desire output are set forth herein as respects a preferred embodiment. In operation, a throughput of 10 seconds or less is easily and maintainably achieved for either hot or cold frothed fluid. Through-put means from operator or consumer selection to complete passage of the full volume of product via the exit aperture. In combination with a high throughput brewing device as described by the author in U.S. application No. 60/626,805, an average of six (6) complete cappuccinos or lattes, for example, can be produced every sixty seconds. The implications of such a rapid, reliable and consistent quality output for retail beverage establishments cannot be overstated.

The embodiments set forth herein are merely illustrative of the principles and applications of the present invention. Numerous modifications may be made to the illustrative embodiments and other arrangements may be devised within the scope of the present invention as taught by the specification, the drawings, and any appended claims.

Although the current preferred embodiment is oriented toward extraction of potable beverages, and in particular bean, leaf or animal product derived beverages, the invention can be used in many other industry applications including but not limited to the plastic extrusion, pharmaceutical packaging, organic and non-organic material processing oriented toward food or cosmetic stuffs, or purification, and other industries.

The embodiments set forth herein are merely illustrative of the principles and applications of the present invention. Numerous modifications may be made to the illustrative embodiments and other arrangements may be devised within the scope of the present invention as taught by the specification, the drawings, and any appended claims

We claim:

1. An improved extraction device wherein said improvement comprises:
means for receiving extractant material;
means for introducing extractant fluid into means for receiving extractant material such that the temperature and pressure undergone by said extractant material is controllable;
means for outletting extractant fluid, where means for outletting includes an aperture, such that the aperture size in the outlet means contributes to the controllable pressure undergone by said extractant material.

2. A device as in claim 1 wherein said means for receiving extractant material is a receiving pocket of predetermined geometry, wherein said receiving pocket is further characterized by a screen interposed between the bottom portion of the extractant material and the outlet means.

3. A device as in claim 2 wherein said screen is positioned adjacent to the floor of the receiving pocket such that a nearly zero volume of air is beneath the extractant material in the receiving pocket.

4. A device as in claim 3 wherein backpressure is created from the combination of the screen and the receiving pocket floor.

5. A device as in claim 1 wherein said means for introducing extractant fluid is a high pressure and between 201 and 206 degrees Fahrenheit.

6. A device as in claim 1 wherein said outletting means includes an aperture of a diameter pre-selected to combine with other aspects of the receiving pocket design so as to cause the extractant material to experience pressure of between 130 and 150 pounds per square inch.

7. A device as in claim 1 wherein the throughput rate is 5 to 12 seconds per 6-8 ounces extractant.

8. A device as in claim 1 where the extractant is ground coffee beans.

9. A device for frothing liquid at controllable temperature comprising:
pressurized gas line;
pressurized fluid line;
a common line formed at a junction of pressurized gas line and pressurized fluid line; and
a porous feature through which the contents of the common line must pass before exiting though the output aperture.

10. A device as in claim 7 wherein the fluid in the fluid line is chilled.

11. A device as in claim 7 wherein the fluid is potable.

12. A device as in claim 7 wherein the fluid is milk.

13. A device as in claim 7 wherein the gas line is under pressure of between about twenty to eighty pounds per square inch.

14. A device as in claim 7 wherein the porous feature is a porous disc of about approximately 2/16ths- 4/16ths inch in thickness.

15. A system for extraction employing the device of claim 1.

16. A system for extraction as in claim 15 employing the device of claim 9.

17. An improved method for extraction under controlled temperature and pressure wherein the improvement includes the step of creating backpressure from the pre-configuration of a screen element and a receiving pocket.

18. An improved method as in claim 17 where the extractant material is coffee.

19. An improved method as in claim 18 further including the step of adding frothed liquid to the extractant material.

20. An improved method as in claim 19 wherein said frothed liquid is chilled.

21. An improved method as in claim 20 wherein said liquid is milk.
